(19) United States
(12) Patent Application Publication
(10) Pub. No.: US 2010/0296572 A1
(43) Pub. Date: Nov. 25, 2010

(54) METHODS AND SYSTEMS FOR TRANSCODING WITHIN THE DISTRIBUTIION CHAIN

(76) Inventors: Kumar Ramaswamy, Princeton, NJ (US); Jean Macher, Washington, DC (US); Gary Robert Gutknecht, Noblesville, IN (US)

Correspondence Address: Robert D. Shedd, Patent Operations;THOMSON Licensing LLC, P.O. Box 5312, Princeton, NJ, 08543-5312, US

(21) Appl. No.: 12/735,011

(22) PCT Filed: Jul. 16, 2008
(86) PCT No.: PCT/US2008/008661

§ 371 Date: Jun. 9, 2010

Related U.S. Application Data
(60) Provisional application No. 61/007,140, filed on Dec. 11, 2007.

(51) Int. Cl. H04N 11/04

(52) U.S. Cl. 375/240.01; 375/E07.267

(57) ABSTRACT

Methods and systems are provided for transcoding within the distribution chain and remotely controlling transcoding. A method includes receiving (210) a first program and an in-band signal with respect to the first program at a signal processing facility. The method further includes transcoding (215) the first program at the signal processing facility according to at least one parameter specified by the in-band signal.

### CROSS-REFERENCE TO RELATED APPLICATIONS

This application claims the benefit of U.S. Provisional Application, “Transcoding within the Distribution Chain”, Ser. No. 61/007,140, filed Dec. 11, 2007, which is incorporated by reference herein in its entirety.

### TECHNICAL FIELD

The present principles relate generally to transcoding and, more particularly, to methods and systems for transcoding within the distribution chain and remotely controlling transcoding quality.

### BACKGROUND

In a cable infrastructure (as with other content distribution infrastructures), there is a need to transcode from a more efficient compressed video format (e.g., the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”)) on the input to a legacy compressed video format (e.g., the ISO/IEC Moving Picture Experts Group-2 Standard (hereinafter the “MPEG-2 Standard”)) on the output. This transcoding function is carried out at the regional head end. When carried out by the content owner on a channel-by-channel basis, it is desirable that the output rate of the transcoding function be controlled from the head end. This allows for different code rates for different types of content. Typically, the head end controls link layer parameters in the regional head end (such as, for example, which satellite transponder to look at, which program to filter, and so forth).

In the transcoding control application, the head end further controls the rate at which the transcoding function must be carried out. Thus, the head end achieves remote management of the bit rate delivered to the local operator (e.g., the cable operator).

Most in-band control in the past has been limited to radio link parameters (e.g., satellite, code rate, and so forth) and transport parameters (e.g., which packet identifier (PID) to filter).

### SUMMARY

These and other drawbacks and disadvantages of the prior art are addressed by the present principles, which are directed to methods and systems for transcoding within the distribution chain and remotely controlling transcoding quality.

According to an aspect of the present principles, there is provided a method. The method includes receiving a first program and an in-band signal with respect to the first program at a signal processing facility. The method further includes transcoding the first program at the signal processing facility according to at least one parameter specified by the in-band signal.

According to another aspect of the present principles, there is provided a system. The system includes a receiver for receiving a first program and an in-band signal with respect to the first program at a signal processing facility. The system further includes a transcoder for transcoding the first program according to at least one parameter specified by the in-band signal.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary system for transcoding MPEG-4 AVC Standard content to MPEG-2 Standard content on a per-channel basis, in accordance with an embodiment of the present principles;

FIG. 2 is a flow diagram for an exemplary method for transcoding MPEG-4 AVC Standard content to MPEG-2 Standard content on a per-channel basis, in accordance with an embodiment of the present principles;

FIG. 3 is a block diagram for an exemplary system for transcoding MPEG-4 AVC Standard content to MPEG-2 Standard content on an all-channel basis, in accordance with an embodiment of the present principles; and

FIG. 4 is a flow diagram for an exemplary method for transcoding MPEG-4 AVC Standard content to MPEG-2 Standard content on an all-channel basis, in accordance with an embodiment of the present principles.

### DETAILED DESCRIPTION

The present principles are directed to methods and systems for transcoding within the distribution chain and remotely controlling transcoding quality.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the MPEG-2 Standard and the MPEG-4 AVC standard, the present principles are not limited to solely these standards and, thus, may be utilized with respect to other video coding standards, recommendations, and extensions thereof, while maintaining the spirit of the present principles.

As noted above, the present principles are directed to methods and systems for transcoding within the distribution chain and remotely controlling transcoding quality.

In one or more embodiments directed to transcoding within the distribution chain, methods and systems are provided for obtaining efficient use of a digital channel in a cable network. One or more of these methods and systems may involve, for example, decoding and re-encoding content to fit into a single quadrature amplitude modulation (QAM) carrier.

In one or more embodiments directed to a remote transcoding application, methods and systems are provided for remotely controlling the quality of the transcoding application. In an embodiment, this may be accomplished on the fly from the primary head end (also interchangeably referred to herein as the first or primary signal processing facility) by sending down in-band parameter control information to control the quality and bit rate of the resulting transcode operation.

As broadcasters/content-owners transition high definition (HD) distribution to more efficient compressed video formats such as the MPEG-4 AVC Standard, there is a natural question as to how this can be accomplished. Within the United States of America cable infrastructure, there is still the need to deliver video to the end customer in a format in accordance with the MPEG2 Standard (hereafter interchangeably referred to as the “MPEG-2 format”). Hence, there is a need for transcoding from the MPEG-4 AVC Standard to the MPEG-2 Standard (both for high definition and possibly standard definition (SD) content). The following describe a couple of ways to accomplish this:

In the following text, the broadcaster is the owner (and usually the creator) of the content. The regional head end (may also be referred to as a secondary signal processing facility) is owned/operated by the cable operator. In some instances, the broadcaster/content owner may have terminating equipment in a regional facility.
The broadcaster/content-owner receives the content at the cable regional head end, demodulates the satellite feed (this could be DVBS-1 or DVBS-2) and decodes the MPEG-4 AVC Standard signal and then re-encodes the MPEG-4 AVC Standard signal into the MPEG-2 format. Alternatively, a transcoding from the MPEG-4 AVC Standard to the MPEG-2 Standard could also be carried out without decoding to baseband. The MPEG-2 Standard signal is then fed into the cable infrastructure as a constant bit rate or variable bit rate stream.
The broadcaster/content-owner could work with the cable operator and agree on a given quality requirement. The satellite signal is demodulated, descrambled and a transport stream is fed over an asynchronous serial interface (ASI) or Gigabit Ethernet interface into the cable infrastructure that includes a statistical multiplexer (stat-mux). Additional video streams could be fed into the same infrastructure. All the content streams are decoded and then re-encoded with variable bit rate (VBR) allocation to simultaneously satisfy the quality constraints and to optimally allocate bits to the various streams to fit into a single QAM carrier.

The disclosure provided herein addresses the merits and challenges of both approaches. It is to be appreciated that given the teachings of the present principles provided herein, one of ordinary skill in this and related arts will readily be able to apply the present principles to both approaches, while maintaining the spirit of the present principles. However, it is to be further appreciated that embodiments directed to the second approach are preferable in that the second approach results in a better utilization of the overall cable spectrum while being able to guarantee a quality constraint imposed by the broadcaster/content owner.

There is a very strong incentive for content-owners (including broadcasters) to transition primary distribution over satellite to regional cable head ends to advanced compression formats. The MPEG-4 AVC Standard is a leading candidate for such distribution applications. The MPEG-4 AVC Standard has the potential to offer a 2:1 improvement in compression efficiency at comparable quality versus the MPEG-2 Standard. This is particularly attractive as high definition content proliferates. In the specific case of cable operators in the United States of America, the final distribution to the consumer for broadcast content will continue to be based on the MPEG-2 Standard for a number of years. This is driven by the installed base of MPEG-2 Standard based set top boxes in the field. Given this requirement, there will be a need to have a transcoding or re-encoding application at the regional head end that converts the MPEG-4 AVC Standard content from primary distribution to MPEG-2 Standard content for final distribution to the consumer.

The regional head end is usually operated by the cable operator. The regional head end aggregates content from many sources (including content from broadcasters). Depending on the distribution system, the content owner (e.g., a national broadcaster) may have a national distribution system and, hence, will place equipment in the cable operator's regional head end (or may specify this equipment for the cable operator) and hand over a demodulated signal to the cable operator.

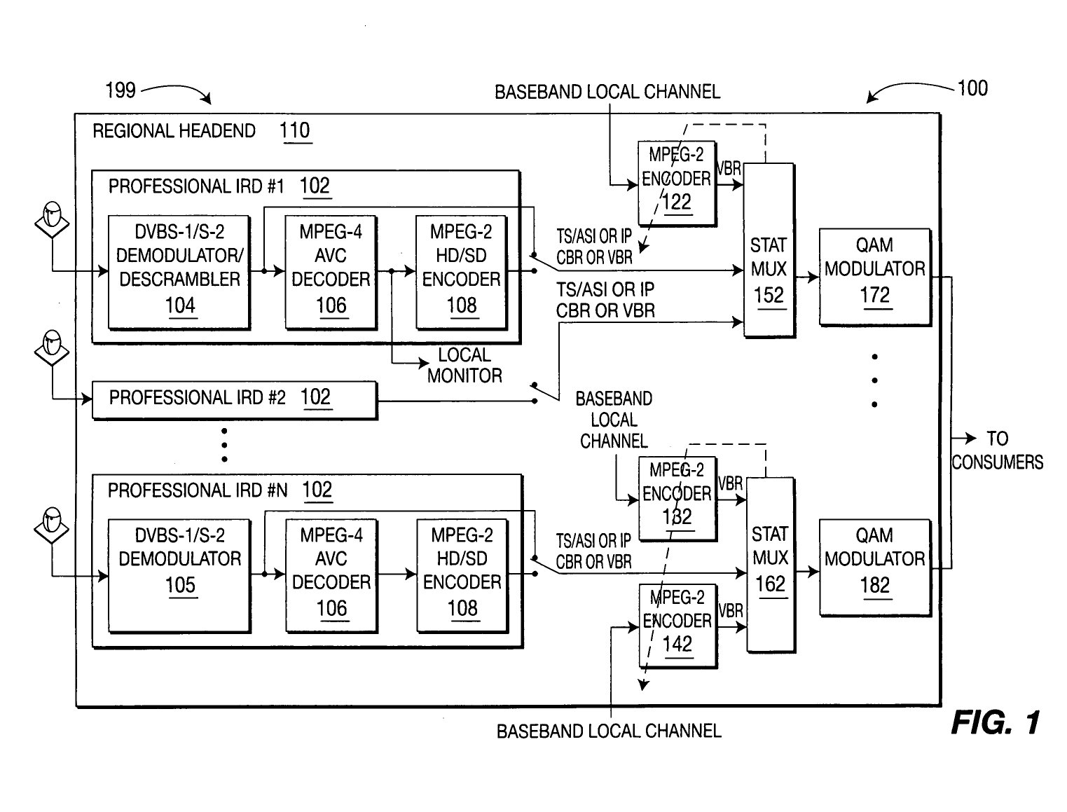

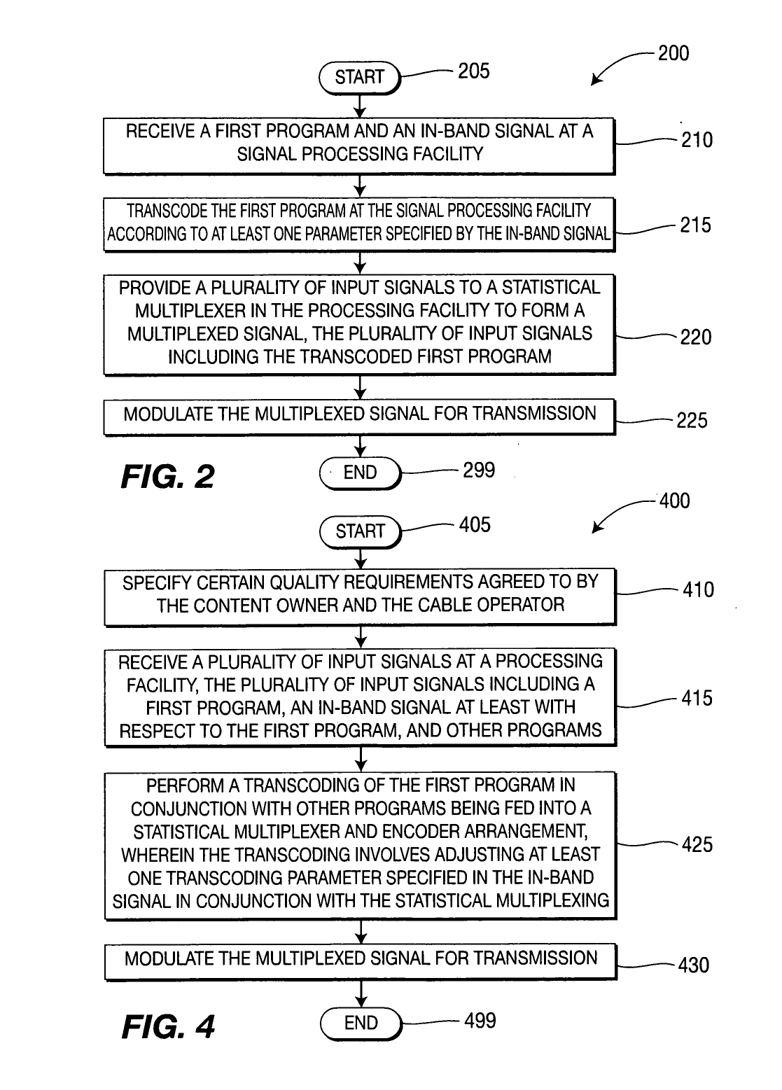

The first approach to accomplishing this transcoding function would be for the content-owner to install satellite demodulation (DVBS-1 or DVBS-2) and the MPEG-4 AVC Standard to MPEG-2 Standard transcoding functionality. The first approach is illustrated with respect to FIGS. 1 and 2.

The in-band signal originates from the primary head end and is carried along with the content. In an embodiment, the in-band signal may use a different transport packet identifier (PID) as compared to the content, if MPEG-2 transport is being used.

Turning to FIG. 1, an exemplary system for transcoding MPEG-4 AVC Standard content to MPEG-2 Standard content on a per-channel basis is indicated generally by the reference numeral 100.

The system 100 includes a regional head end 110. The regional head end 110 includes professional integrated receiver/decoder number 1 (IRD#1) through professional IRD#N (collectively designated by the reference numeral 102, and individually designated by the corresponding number of the professional IRD). The regional head end 110 also includes a switch 112, a switch 114, an MPEG-2 Standard encoder 122, an MPEG-2 Standard encoder 132, an MPEG-2 Standard encoder 142, a statistical-multiplexer 152, a statistical multiplexer 162, and respective QAM modulators 172, . . . , 182.

Professional IRD#1 includes a DVBS-1/S-2 demodulator/descrambler 104, an MPEG-4 AVC Standard decoder 106, and an MPEG-2 high definition/standard definition (HD/SD) encoder 108. Professional IRD#N includes a DVBS-1/S-2 demodulator 105, an MPEG-4 AVC Standard decoder 106, and an MPEG-2 high definition/standard definition (HD/SD) encoder 108. Professional IRD#2 through professional IRD#N−1 are similar to professional IRD#N.

With respect to professional IRD#1, an output of the DVBS-1/S-2 demodulator/descrambler 104 is connected in signal communication with an input of the MPEG-4 AVC Standard decoder 106, and to a second input of the switch 112. An output of the MPEG-4 AVC Standard decoder 106 is connected in signal communication to an input of the MPEG-2 HD/SD encoder 108. For at least professional IRD#1, the output of the MPEG-4 AVC Standard decoder 106 is also connected in signal communication with a local monitor. An output of the MPEG-2 HD/SD encoder 108 is connected in signal communication with a first input of the switch 112.

An output of the switch 112 is connected in signal communication with a second input of the statistical-multiplexer (stat-mux) 152. An output of the stat-mux 152 is connected in signal communication with an input of a QAM modulator 172. An output of the MPEG-2 encoder 122 is connected in signal communication with a first input of the stat-mux 152. An output of the professional IRD#2 is connected in signal communication with a third input of the stat-mux 152. A control output of the stat-mux 152 is connected in signal communication with a control input of the MPEG-2 encoder 122.

With respect to professional IRD#N, an output of the DVBS-1/S-2 demodulator 105 is connected in signal communication with an input of the MPEG-4 AVC Standard decoder 106, and to a second input of the switch 114. An output of the MPEG-4 AVC Standard decoder 106 is connected in signal communication to an input of the MPEG-2 HD/SD encoder 108. An output of the MPEG-2 HD/SD encoder 108 is connected in signal communication with a first input of the switch 114.

An output of the switch 114 is connected in signal communication with a second input of the statistical-multiplexer (stat-mux) 162. An output of the stat-mux 162 is connected in signal communication with an input of a QAM modulator 182. An output of the MPEG-2 encoder 132 is connected in signal communication with a first input of the stat-mux 162. An output of the MPEG-2 encoder 142 is connected in signal communication with a third input of the stat-mux 162. A control output of the stat-mux 162 is connected in signal communication with a control input of the MPEG-2 encoder 132 and a control input of the MPEG-2 encoder 142.

Respective inputs of the DVBS-1/S-2 demodulator/descrambler 104 and/or DVBS-1/S-2 demodulator 105 are available as inputs of the system 100, for receiving content encoded in accordance with the MPEG-4 AVC Standard (hereinafter “MPEG-4 AVC content”). Respective inputs of the MPEG-2 encoder 122, MPEG-2 encoder 132, and MPEG-2 encoder 142 are available as inputs of the system 100, for receiving a baseband local channel. Respective outputs of the QAM modulator 172 and the QAM modulator 182 are available as outputs of the system 100, for outputting content in accordance with the MPEG-2 Standard (hereinafter “MPEG-2 content”).

It is to be appreciated that, depending upon how system 100 is segmented, one or more elements of system 100 may be considered to be a receiver in that the one or more elements receive one or more signals.

Moreover, in FIG. 1, transcoder elements, e.g., MPEG-4 AVC decoders 106 and MPEG encoders 108, are collectively represented as transcoder 199 (i.e., the combination of decoder 106 and encoder 108 performs the transcoding function).

Turning to FIG. 2, an exemplary method for transcoding MPEG-4 AVC Standard content to MPEG-2 Standard content on a per-channel basis is indicated generally by the reference numeral 200.

The method 200 includes a start block 205 that passes control to a function block 210. The function block 210 receives an in-band signal at a signal processing facility, and passes control to a function block 215. In one embodiment, the in-band signal may be sent from a primary signal processing facility, e.g., a primary head end, to a secondary signal processing facility, e.g., a regional head end. The function block 215 transcodes a first program at the secondary signal processing facility according to one or more parameters specified by the in-band signal, and passes control to a function block 220. The function block 220 provides a plurality of input signals to a statistical multiplexer in the secondary processing facility to form a multiplexed signal, the plurality of input signals including the transcoded first program, and passes control to a function block 225. The function block 225 modulates the multiplexed signal for transmission, and passes control to an end block 299. In the embodiment of FIG. 2, the transcoding is not done in conjunction with a stat-mux pool and is, hence, referred to being done on an independent, “per channel” or “per program” basis, i.e., transcoding for a channel or program being done independently of other channels or programs.

Referring back to FIG. 1, the regional head end receives content over the DVBS-1/2 infrastructure and demodulates and descrambles the content. If the content is in the MPEG-2 format, the content bypasses the MPEG-4 AVC Standard to MPEG-2 Standard transcoding infrastructure and is fed directly to the downstream statistical multiplexers 152 and 162. If the content is in the MPEG-4 AVC Standard format, the content needs to be transcoded into the MPEG-2 Standard and then fed either over an ASI or Gigabit Ethernet infrastructure to the downstream statistical multiplexers 152 and 162. In either case, the downstream statistical multiplexers 152 and 162 could receive either a constant bit rate (CBR) stream or a variable bit rate (VBR) stream.

Constant bit rate (CBR) schemes are usually specified in terms of a fixed bit rate over a given time window and a peak variation with respect to that rate. Variable bit rate (VBR), or capped VBR, schemes are usually specified in terms of an average bit rate (averaged over a specified time window) and a peak bit rate that will not be exceeded. In the case of a CBR signal, the cable operator has to dedicate the bandwidth on a QAM carrier to carry the program untouched to the end consumer. In the case of a VBR signal, if by contract the cable operator needs to carry the stream untouched, then the statistical multiplexers 152 and 162 need to accommodate this signal and perform rate allocation with this constraint on the other encoders that share the same multiplexer.

With respect to the embodiment shown and described with respect to FIG. 1, the statistical multiplexers 152 and 162 only control the bit rate allocation of the local baseband channels being encoded. For the purposes of the statistical multiplexers 152 and 162, the channels coming from the primary head end (either CBR or VBR) are a pass through and their bit rates must simply be subtracted from the overall bit rate and the remainder made available for local channel encoding. Hence, this type of multiplexing is referred to as open loop statistical multiplexer control.

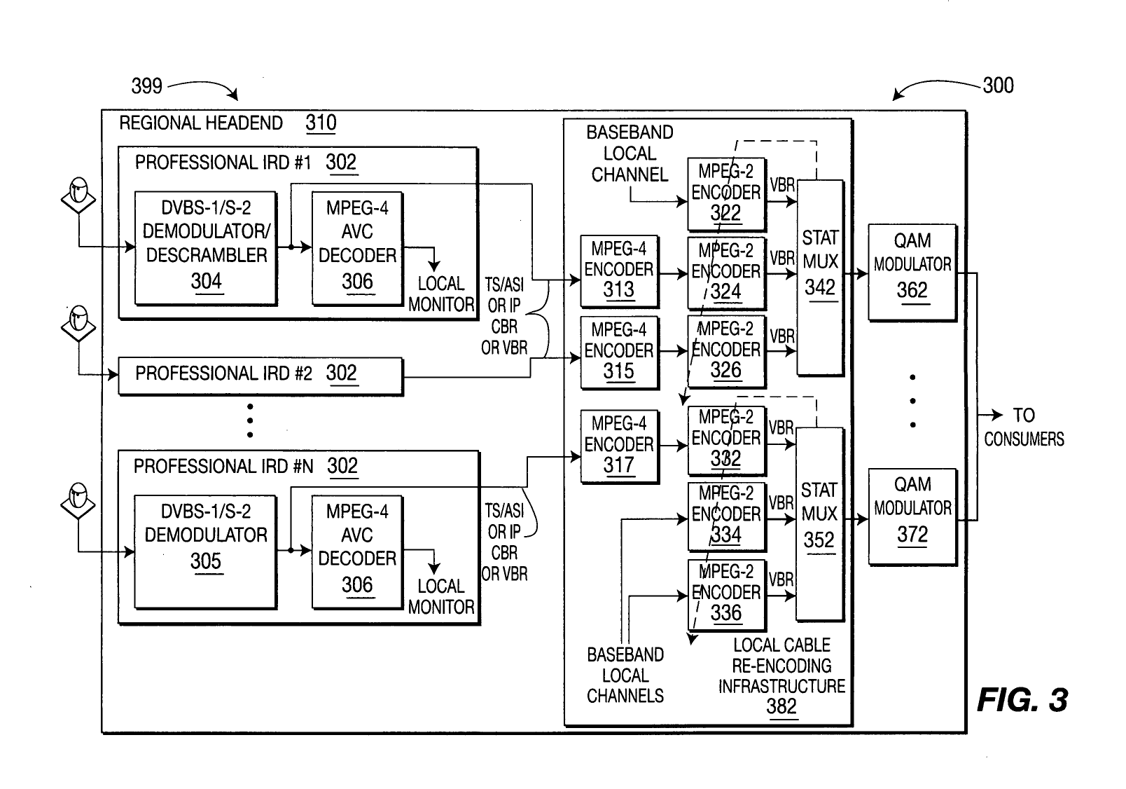

In either the open-loop VBR or CBR inputs, the cable operator needs to employ a blended or hybrid statistical multiplexing on the other inputs. This is known to be less efficient than a complete closed loop VBR approach. (Closed loop statistical multiplexer control will be discussed with respect to an embodiment shown in FIG. 3, in which all the inputs into the statistical multiplexer pool of channels have been converted to baseband, and the bit allocation of every program can be controlled by the statistical multiplexer.)

For a given average bit rate (where the average bit rate is the nominal CBR bit rate and the average bit rate of the VBR scheme), the VBR scheme will have superior performance. Also, a VBR stream, with no feedback rate control, fed into a statistical multiplexer could result in a reduced performance than would be possible with feedback rate control.

The transcoding function itself could be full MPEG-4 AVC Standard decode and a re-encode into the MPEG-2 Standard (both HD and/or SD), or a partial MPEG-4 AVC Standard decode (entropy decoding and a few other steps) and a re-encode into the MPEG-2 Standard using information such as motion vectors and a subset of the mode decisions.

Both approaches, namely the full decode approach and the partial decode approach which both can be used in the scheme of FIG. 1, could benefit from side information provided by the first MPEG-4 AVC Standard encoder and this requires a very modest amount of additional satellite bandwidth.

Additionally, the content owner may have in-band control of the encode/transcode quality. This can be accomplished by sending control words to control the parameters which, in turn, guide the quality and bit rate of the MPEG-4 AVC Standard to MPEG-2 Standard transcode function.

For example, one or more of the following parameters may be passed to the regional MPEG-2 Standard transcoder: output bit rate (CBR or VBR details); choice of group of pictures (GOP) structures; quality metrics (e.g., peak signal-to-noise ratio (PSNR), subjectively weighted PSNR, and so forth) and so forth. Such parameters can be switched on the fly at, for example, a GOP level, to control the quality of the downstream transcoded output.

This approach in accordance with an embodiment, where the content-owner has complete control over the transcode operation, has appeal from the viewpoint of both the content-owner and the cable operator. This approach is essentially a pass-through scheme from the viewpoint of the cable operator (thus satisfying any obligations on quality). This approach also allows the content-owner to be responsible for the quality of their content as the content gets delivered to an end consumer. However, it is not very efficient from the viewpoint of the usage of the QAM bandwidth. For given quality goals, getting complete control over the entire available bandwidth to allocate freely over all programs is more efficient than being constrained to not being able to modify some channels (that have to simply be passed through).

The second approach entails a joint effort from the content-owner and the cable operator to optimize the bandwidth usage on the consumer segment while maintaining the same quality of video. The second approach is illustrated with respect to FIGS. 3 and 4.

Turning to FIG. 3, an exemplary system for transcoding MPEG-4 AVC Standard content to MPEG-2 Standard content on an all-channel basis (i.e., transcoding is done in conjunction with statistical multiplexing, and all channels are used in a statistical multiplex pool) is indicated generally by the reference numeral 300.

The system 300 includes a regional head end 310. The regional head end 310 includes professional integrated receiver/decoder number 1 (IRD#1) through professional IRD#N (collectively designated by the reference numeral 302, and individually designated by the corresponding number of the professional IRD). The regional head end further includes the local cable re-encoding infrastructure 382 and respective QAM modulators 362, . . . , 372.

Professional IRD#1 includes a DVBS-1/S-2 demodulator/descrambler 304 and an MPEG-4 AVC Standard decoder 306. Professional IRD#N includes a DVBS-1/S-2 demodulator 305, an MPEG-4 AVC Standard decoder 306. Professional IRD#2 through professional IRD#N−1 is similar to professional IRD#N.

With respect to professional IRD#1, an output of the DVBS-1/S-2 demodulator/descrambler 304 is connected in signal communication with an input of the MPEG-4 AVC Standard decoder 306 and an input of an MPEG-4 AVC decoder 313. An output of the MPEG-4 AVC Standard decoder 306 is connected in signal communication with a local monitor.

With respect to professional IRD#2, an output thereof is connected in signal communication with an input of an MPEG-4 AVC decoder 315.

With respect to professional IRD#N, an output of a DVBS-1/S-2 demodulator 305 is connected in signal communication with an input of the MPEG-4 AVC Standard decoder 306 and an input of an MPEG-4 AVC decoder 317. An output of the MPEG-4 AVC Standard decoder 306 is connected in signal communication with a local monitor.

An output of the MPEG-4 AVC decoder 313 is connected in signal communication with an input of an MPEG-2 encoder 324. An output of the MPEG-4 AVC decoder 315 is connected in signal communication with an input of an MPEG-2 encoder 326. An output of the MPEG-4 AVC decoder 317 is connected in signal communication with an input of an MPEG-2 encoder 332.

An output of an MPEG-2 encoder 322 is connected in signal communication with a first input of a statistical multiplexer 342. An output of the MPEG-2 encoder 324 is connected in signal communication with a second input of the statistical multiplexer 342. An output of the MPEG-2 encoder 326 is connected in signal communication with a third input of the statistical multiplexer 342.

An output of an MPEG-2 encoder 332 is connected in signal communication with a first input of a statistical multiplexer 352. An output of the MPEG-2 encoder 334 is connected in signal communication with a second input of the statistical multiplexer 352. An output of the MPEG-2 encoder 336 is connected in signal communication with a third input of the statistical multiplexer 352.

An output of the statistical multiplexer 342 is connected in signal communication with an input of a QAM modulator 362. An output of the statistical multiplexer 352 is connected in signal communication with an input of a QAM modulator 372.

Respective inputs of the DVBS-1/S-2 demodulator/descrambler 304 and/or DVBS-1/S-2 demodulator 305 are available as inputs of the system 300, for receiving content encoded in accordance with the MPEG-4 AVC Standard (hereinafter “MPEG-4 AVC content”). Respective inputs of the MPEG-2 encoder 322, MPEG-2 encoder 334, and MPEG-2 encoder 336 are available as inputs of the system 300, for receiving a baseband local channel. Respective outputs of the QAM modulator 362 and the QAM modulator 372 are available as outputs of the system 300, for outputting content in accordance with the MPEG-2 Standard (hereinafter “MPEG-2 content”).

It is to be appreciated that, depending upon how system 300 is segmented, one or more elements of system 300 may be considered to be a receiver in that the one or more elements receive one or more signals.

Moreover, in FIG. 3, transcoder elements (e.g., MPEG-4 AVC decoders 313, 315, 317, and MPEG encoders 324, 326, 332) are collectively represented as transcoder 399. For example, the combination of decoder 313 and encoder 324 performs a single channel transcoding function, while the combination of decoder 315 and encoder 326 performs transcoding on another channel, and so on.

Turning to FIG. 4, an exemplary method for transcoding MPEG-4 AVC Standard content to MPEG-2 Standard content on an all-channel basis, which involves a joint optimization using all channels, with transcoding being done in conjunction with statistical multiplexing, is indicated generally by the reference numeral 400.

The method 400 includes a start block 405 that passes control to a function block 410. The function block 410 specifies certain quality requirements agreed to by the content owner and the cable operator, and passes control to a function block 415. The function block 415 receives a plurality of input signals at a signal processing facility, the plurality of input signals including a first program, an in-band signal at least with respect to the first program, and other programs, and passes control to a function block 425. In one embodiment, the in-band signal is sent from a first signal processing facility to a second signal processing facility, e.g., from a primary head end to a regional head end. The function block 425 performs a transcoding of the first program in conjunction with the other programs being fed into a statistical multiplexer and encoder arrangement, wherein the transcoding involves adjusting at least one transcoding parameter specified in the in-band signal in conjunction with the statistical multiplexing, and passes control to a function block 430. The function block 430 modulates the multiplexed signal for transmission, and passes control to an end block 499.

It is to be appreciated that the at least one transcoding parameter mentioned with respect to function block 425 corresponds to at least one of the certain quality requirements mentioned with respect to function block 410.

In the second approach, the content owner demodulates, descrambles (e.g., using DVBS-1/S-2 demodulator/descrambler 104 and DVBS-1/S-2 demodulator 105) and passes the MPEG-4 AVC Standard stream carried over ASI or Gigabit Ethernet to the cable operator. There is an umbrella agreement on quality (most likely defined by objective measures such as peak signal-to-noise ratio (PSNR) even though other quantifiable subjective metrics could be considered as well). Using this quality measure, the re-encode operation is carried out in conjunction with other programs fed into a statistical multiplexer and MPEG-2 encoder arrangement. It is conceivable that the content owner may be able to specify the constraints to the transcoding process by sending down in-band control parameters to the stat-multiplexers 342 and 352.

Also, some information from the original compressed bitstream may also be made available to the MPEG-2 Standard encoder so that a full re-encode may not be necessary as with the single channel approach.

The second approach (involving the statistical multiplexing pool, i.e., the all channel approach) is expected to be able to accommodate 3 high definition MPEG-2

Standard channels in a single QAM carrier carrying a payload of approximately 38 Mbits/second. This implies an average video payload per channel of about 12 Mbits/second, and is believed to equate to similar quality achievable with a VBR scheme with a peak data rate of about 18 Mbits/second. This gain would be accomplished due to the use of intelligence in the statistical multiplexing. Since this is very content dependent, it would help to statistically multiplex channels of varying complexity to better achieve this goal.

Based on the inventors' current subjective testing, high definition MPEG-2 peak rates of 18 Mbits/second (with average of 12 Mbits/sec) are acceptable for distribution of most content to the customers. What remains to be determined is the average bit rates to be used for primary distribution (e.g., from the primary headend to the regional headend) of the MPEG-4 AVC Standard content. Since the high definition MPEG-2 content may reach a limit in quality that is constrained by the transcoding process, the MPEG-4 AVC Standard primary distribution scheme may be configured accordingly, e.g., by selecting average bit rates to provide a proper balance between overall signal quality and bandwidth requirements.

Hence, it is recommended to provide an approach where the statistical multiplexing gains over the entire QAM carrier can be realized in the MPEG-4 AVC-to-MPEG2 transcode function. In order for this to be implemented successfully, it is preferable that all encodes/transcodes to the MPEG-2 Standard be realized within the control of the statistical multiplexer that creates a bit stream for the QAM modulator in the regional head end, which may require an agreement between the content owner and the cable operator to agree on encoding quality (subjective or objective).

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
receiving a first program and an in-band signal with respect to the first program at a signal processing facility; and
transcoding the first program at the signal processing facility according to at least one parameter specified by the in-band signal.

2. The method of claim 1, further comprising:
providing a plurality of input signals to a statistical multiplexer in the signal processing facility to form a multiplexed signal, the plurality of input signals including the transcoded first program; and
modulating the multiplexed signal for transmission.

3. The method of claim 2, wherein the transcoding of the first program further comprises:
adjusting at least one transcoding parameter in conjunction with statistical multiplexing of the plurality of input signals.

4. The method of claim 3, wherein the at least one transcoding parameter comprises at least one of an output bit rate, a choice of a group of pictures structure, and a quality metric.

5. The method of claim 3, wherein the at least one transcoding parameter is dynamically adjusted during said transcoding step.

6. The method of claim 3, wherein the plurality of input signals include a plurality of programs, all of the plurality of programs being statistically multiplexed using a statistical multiplexing pool that optimizes bandwidth subject to the at least one transcoding parameter.

7. The method of claim 6, wherein the at least one transcoding parameter is determined based on an agreement between a content owner and a content provider different than the content owner.

8. The method of claim 2, wherein the plurality of input signals including a plurality of programs, and wherein said transcoding step transcodes each of the plurality of programs on a per-program basis.

9. The method of claim 1, wherein the one or more parameters specified by the in-band signal are fixed according to content owner requirements imposed on the first program.

10. The method of claim 1, wherein the signal processing facility is a regional head end.

11. A system, comprising:
a receiver for receiving a first program and an in-band signal with respect to the first program at a signal processing facility; and
a transcoder for transcoding the first program according to at least one parameter specified by the in-band signal.

12. The system of claim 11, further comprising:
a statistical multiplexer for statistically multiplexing a plurality of input signals to form a multiplexed signal, the plurality of input signals including the transcoded first program; and
a modulator for modulating the multiplexed signal for transmission.

13. The system of claim 12, wherein the transcoder is configured for adjusting at least one transcoding parameter in conjunction with statistical multiplexing of the plurality of input signals.

14. The system of claim 13, wherein the at least one transcoding parameter comprises at least one of an output bit rate, a choice of a group of pictures structure, and a quality metric.

15. The system of claim 13, wherein the transcoder is configured for dynamically adjusting the at least one transcoding parameter during the transcoding.

16. The system of claim 13, wherein the plurality of input signals include a plurality of programs, all of the plurality of programs being statistically multiplexed using a statistical multiplexing pool that optimizes bandwidth subject to the at least one transcoding parameter.

17. The system of claim 11, wherein the signal processing facility is a regional head end.

18. The system of claim 12, wherein the plurality of input signals including a plurality of programs, and wherein each of the plurality of programs is transcoded on a per-program basis.

19. The system of claim 11, wherein the at least one parameter specified by the in-band signal are fixed according to content owner requirements imposed on the first program.

20. The system of claim 11, wherein the transcoding of the first program is less than a full re-encoding of the first program from a source format to a target format.
